(19) United States
(12) Patent Application Publication
(10) Pub. No.: US 2008/0149140 A1
(43) Pub. Date: Jun. 26, 2008

(54) Drainpipe Cleaning Method and Drainpipe Cleaning Apparatus

(75) Inventors: Makoto Ono, Tokyo (JP); Masaaki Okuda, Osaka (JP); Masaaki Hashimoto, Matsubara-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: Japan Airlines International Co., Ltd., Shinagawa-ku, TOKYO (JP); Seiwa Pro Co., Ltd., Matsubara, OSAKA (JP)

(21) Appl. No.: 10/567,014

(22) PCT Filed: Mar. 29, 2005
(86) PCT No.: PCT/JP05/05819

§ 371 Date: Feb. 2, 2006

(51) Int. Cl. B08B 9/027

(52) U.S. Cl. 134/21; 134/57 R

(57) ABSTRACT

A drainpipe cleaning apparatus prevents leakage of cleaning fluid from the drainpipe while cleaning the drainpipe. The drainpipe cleaning apparatus 1 has a cleaning fluid tank 10 for storing the cleaning fluid, a fluid delivery line 15, fluid drain line 23, gas-liquid separation tank 24, gas exhaust line 26, circulation line 28, gas recovery line 31, cleaning fluid return line 33, and control device 45. The control device 45 runs a cleaning process by driving a gas discharge pump 36 to create negative pressure inside the wastewater drainpipe 2 in a transit vessel and driving a cleaning fluid pump 16 to cause the cleaning fluid to flow backwards through the wastewater pipe 2. The control device 45 also monitors the pressure detected by a inlet-side pressure detector 20 during the cleaning process. If the detected pressure exceeds atmospheric pressure, the control device 45 runs a cleaning fluid recovery process that stops the cleaning fluid pump 16, closes the discharge valve 19, opens the cleaning fluid return valve 34, opens the release valve 27, and closes the gas recovery valve 32 so that cleaning fluid in the wastewater pipe 2 flows back through the fluid delivery line 15 and cleaning fluid return line 33 and is recovered in the cleaning fluid tank 10.

### TECHNICAL FIELD

The present invention, directed to drainpipes installed inside transit vessels, relates to drainpipe cleaning methods and drainpipe cleaning apparatuses for cleaning the interior of such drainpipes to remove scale deposited on the inner walls.

### BACKGROUND ART

In restrooms installed in transit vessels such as passenger aircraft, the drainpipes connected to the sink drains, toilet bowls, etc. become encrusted along their inside walls with calcium compounds and other deposits (such deposited matter will be termed “scale” hereinafter) from use. Scale buildup in the drainpipes leads to deteriorated draining capability and to clogging, and is the cause of foul odors and other unpleasantness. Consequently, it is essential to clear away the buildup periodically.

Scale is conventionally cleared away by removing drainpipes from a transit vessel to clean them, but since the internal structure of the transit vessel is complex the configuration of the drainpipes will also be complicated, such that removing and reinstalling the drainpipes is time consuming and labor intensive.

To address these problems, apparatuses with which drainpipes can be cleaned efficiently without removing them from a transit vessel have been proposed, as with the drainpipe cleaning apparatus disclosed in Int'l. Pat. App. Pub. No. WO 03/022467, for example.

Among its constituent components, this drainpipe washing apparatus comprises: a cleaning fluid tank for storing a cleaning fluid; an evacuation pump for externally evacuating air inside the cleaning fluid tank to reduce the pressure inside the tank; a fluid feed pipe having one end connected to the downstream end of a wastewater drainpipe; a fluid feed pump connected to the cleaning fluid tank for pressurizing the cleaning fluid inside the tank to supply the cleaning fluid to the other end of the fluid feed pipe; a cleaning fluid drainpipe having one end connected to the upstream end of the wastewater drainpipe; a gas-liquid separation tank connected to the other end of the cleaning fluid drainpipe for separating off gas within cleaning fluid recovered from the cleaning fluid drainpipe; a return pipe having one end connected to the gas-liquid separation tank and the other end connected to the cleaning fluid tank for returning to the cleaning fluid tank recovered cleaning fluid in the gas-liquid separation tank; and a gas recovery pipe having one end connected to the gas-liquid separation tank and the other end connected to the cleaning fluid tank for recovering into the cleaning fluid tank the gas separated in the gas-liquid separation tank.

With this drainpipe washing apparatus, at first gas inside the cleaning fluid tank is evacuated to the exterior with the evacuation pump to reduce the pressure within the cleaning fluid feed pipe, wastewater drainpipe, cleaning fluid drainpipe, gas-liquid separation tank, return pipe, and gas recovery pipe, then the cleaning fluid feed pump is driven to supply the cleaning fluid from the cleaning fluid tank through the cleaning fluid feed pipe to the downstream end of the wastewater drainpipe.

The supplied cleaning fluid flows backwards through the wastewater drainpipe, dissolving and removing scale deposited on the inner wall of the wastewater drainpipe. Together with the gases produced in the course of dissolving and removing scale, the cleaning fluid then flows through the cleaning fluid drainpipe and enters the gas-liquid separation tank. The gas component is separated off in the gas-liquid separation tank. The cleaning fluid from which the gas component has been separated off is then returned into the cleaning fluid tank by the return pipe, and the separated gas component is recovered into the cleaning fluid tank by the gas recovery pipe.

Patent Reference 1: Int'l. Pat. App. Pub. No. WO 03/022467

### DISCLOSURE OF INVENTION

### Problems Invention is to Solve

In cleaning out a wastewater drainpipe with this apparatus, the reason that the cleaning fluid tank, cleaning fluid feed pipe, wastewater drainpipe, cleaning fluid drainpipe, gas-liquid separation tank, return pipe, and gas recovery pipe are put under negative pressure is that by putting the pressure of the cleaning fluid flowing through the wastewater drainpipe lower than atmospheric pressure, the cleaning fluid is prevented from leaking out to the exterior. If the cleaning fluid pressure is higher than atmospheric pressure, the cleaning fluid can easily leak from the joints or other discontinuities in the wastewater drainpipe. Furthermore, because the cleaning fluid is acidic, leaking cleaning fluid that comes in contact with a transit vessel will corrode it; therefore, such fouling of the transit vessel can effectively be prevented by reducing the pressure inside the wastewater drainpipe.

Nevertheless, with the conventional drainpipe washing apparatus described above, in a situation, for example, in which scale has become heavily deposited on the inside of a drainpipe such that the inner diameter of the drainpipe is narrowed, when the cleaning fluid feed pump supplies cleaning fluid into the wastewater drainpipe, there is a danger that the pressure of the cleaning fluid inside the wastewater drainpipe will rise above atmospheric pressure such that the cleaning fluid leaks out to the exterior of the pipe.

In view of foregoing circumstances, an object of the present invention is to make available a drainpipe cleaning method and drainpipe cleaning apparatus that make it possible to prevent leakage of cleaning fluid from the drainpipe while the drainpipe is being cleaned.

### Means for Solving the Problems

In order to achieve the foregoing objective, the invention relates to a drainpipe cleaning method for cleaning a drainpipe in a transit vessel. This cleaning method has steps of connecting a cleaning fluid tank that stores cleaning fluid through a fluid delivery line to a downstream end of the drainpipe, and connecting the cleaning fluid tank through a fluid drain line to an upstream end of the drainpipe;

running a cleaning process to clean inside the drainpipe by maintaining a specific negative pressure inside the cleaning fluid tank, fluid delivery line, drainpipe, and fluid drain line while supplying cleaning fluid from the cleaning fluid tank to the downstream end of the drainpipe through the fluid delivery line, reverse-flushing the cleaning fluid through the drainpipe, and circulating the cleaning fluid back to the cleaning fluid tank through the fluid drain line;

detecting and monitoring cleaning fluid pressure inside the fluid delivery line near the drainpipe during the cleaning process; and

running a cleaning fluid recovery process if the detected cleaning fluid pressure exceeds a predetermined pressure, this cleaning fluid recovery process having steps of stopping supplying cleaning fluid to the drainpipe, opening a portion of the fluid drain line to air, and recovering the cleaning fluid in the drainpipe through the fluid delivery line into the cleaning fluid tank.

This drainpipe cleaning method can be desirably executed by the drainpipe cleaning apparatus described below. This drainpipe cleaning apparatus is an apparatus for cleaning a drainpipe in a transit vessel, and has:

a cleaning fluid tank that stores cleaning fluid;

a evacuation means for externally discharging gas inside the cleaning fluid tank and producing negative pressure inside the cleaning fluid tank;

a base pressure detector for detecting pressure inside the cleaning fluid tank;

a fluid delivery line of which one end is connected to the downstream end of the drainpipe;

a fluid delivery means that is connected to the cleaning fluid tank, pressurizes the cleaning fluid in the cleaning fluid tank, and supplies the cleaning fluid to the other end of the fluid delivery line;

a discharge valve provided on the fluid delivery line for opening and closing the conduit inside the fluid delivery line;

a cleaning fluid return line of which one end is connected to the fluid delivery line between the drainpipe and discharge valve, and the other end is connected to the cleaning fluid tank;

a cleaning fluid return valve provided on the cleaning fluid return line for opening and closing the conduit inside the cleaning fluid return line;

a inlet-side pressure detector disposed near the one end of the fluid delivery line for detecting cleaning fluid pressure inside the conduit near this one end;

a fluid drain line of which one end is connected to the upstream end of the drainpipe;

a gas-liquid separation tank connected to the other end of the fluid drain line for separating gas from cleaning fluid recovered from the fluid drain line;

an exhaust line connected to the gas-liquid separation tank for externally exhausting gas inside the gas-liquid separation tank;

a release valve provided on the exhaust line for opening and closing the conduit inside the exhaust line;

a circulation line of which one end is connected to the gas-liquid separation tank and the other end is connected to the cleaning fluid tank for circulating cleaning fluid recovered into the gas-liquid separation tank back to the cleaning fluid tank;

a gas recovery line of which one end is connected to the gas-liquid separation tank and the other end is connected to the cleaning fluid tank for recovering gas separated inside the gas-liquid separation tank into the cleaning fluid tank;

a gas recovery valve provided on the gas recovery line for opening and closing the conduit inside the gas recovery line; and

a control device for controlling operation of the evacuation means, fluid delivery means, discharge valve, cleaning fluid return valve, release valve, and gas recovery valve.

In this drainpipe cleaning apparatus the control device runs a cleaning process by driving the evacuation means and fluid delivery means, opening the discharge valve, closing the cleaning fluid return valve, closing the release valve, and opening the gas recovery valve to produce specific negative pressure inside the cleaning fluid tank, supply cleaning fluid to the downstream end of the drainpipe, reverse-flush the cleaning fluid through the drainpipe, recover the cleaning fluid into the gas-liquid separation tank, and then circulate the cleaning fluid to the cleaning fluid tank. The control device also monitors the pressure detected by the inlet-side pressure detector while running this cleaning process.

If the detected pressure exceeds a predetermined pressure, the control device runs a cleaning fluid recovery process by stopping the fluid delivery means, closing the discharge valve, opening the cleaning fluid return valve, closing the gas recovery valve, and opening the release valve to recover the cleaning fluid in the drainpipe through the fluid delivery line and cleaning fluid return line branching from the fluid delivery line into the cleaning fluid tank.

The cleaning process controlled by the control device in this drainpipe cleaning apparatus executes as follows. First, the discharge valve opens, the cleaning fluid return valve closes, the release valve closes, and the gas recovery valve opens. The evacuation means is then driven to externally vent gas from inside the cleaning fluid tank. This produces and maintains a specific negative pressure inside the cleaning fluid tank, fluid delivery line, drainpipe, fluid drain line, gas-liquid separation tank, circulation line, gas recovery line, and cleaning fluid return line while the fluid delivery means is driven to supply cleaning fluid from the cleaning fluid tank to the fluid delivery line.

The supplied cleaning fluid flows through the fluid delivery line and flows backwards through the drainpipe to dissolve and remove scale deposits from the inside walls of the drainpipe. The cleaning fluid is caused to flow backwards to the normal direction of waste flow in the drainpipe (that is, from the normally downstream end to the normally upstream end of the drainpipe) to apply pressure in the opposite direction as the direction in which the scale grows. This promotes separation of the scale from the walls and improves the scale removal effect (cleaning effect) of the system.

The cleaning fluid reverse-flushing through the drainpipe then flows through the fluid drain line into the gas-liquid separation tank together with the gases produced while dissolving and removing scale. The gas component is separated from the liquid in the gas-liquid separation tank, the degassed cleaning fluid circulates back to the cleaning fluid tank through the circulation line, and the separated gas is recovered into the cleaning fluid tank through the gas recovery line. The gases are separated from the fluid in the gas-liquid separation tank to prevent cleaning fluid surges (hammering) inside the circulation line.

While this cleaning process is running, the control device constantly monitors the pressure detected by the inlet-side pressure detector. If the detected pressure exceeds a specific level, a cleaning fluid recovery process is executed. This cleaning fluid recovery process stops the fluid delivery means, closes the discharge valve, opens the cleaning fluid return valve, closes the gas recovery valve, and opens the release valve. Air thus flows into the gas-liquid separation tank from the exhaust line and through the fluid drain line into the drainpipe. The cleaning fluid in the drainpipe thus flows through the fluid delivery line and cleaning fluid return line, and is recovered into the cleaning fluid tank.

This specific pressure is a reference value for determining if the pressure of the cleaning fluid flowing through the drainpipe is greater than atmospheric pressure. If, for example, large scale deposits on the inside walls of the drainpipe have reduced the inside diameter of the drainpipe, the cleaning fluid pressure inside the drainpipe can rise to above atmospheric pressure and thus create the danger of cleaning fluid leaking from the joints of the drainpipe. The cleaning fluid recovery process is therefore run if the detected pressure exceeds the specific pressure in order to prevent cleaning fluid leaks.

As described above, the drainpipe cleaning method and drainpipe cleaning apparatus according to the invention detect and monitor the cleaning fluid pressure inside the fluid delivery line at the drainpipe inlet by means of the inlet-side pressure detector while running the cleaning process, and if the detected pressure is greater than or equal to atmospheric pressure, determine that the cleaning fluid pressure inside the drainpipe exceeds atmospheric pressure and therefore run the cleaning fluid recovery process. The invention can thus clean the drainpipe while effectively pre-exhausting cleaning fluid from leaking from the drainpipe.

In another aspect of the invention the control device preferably restarts the cleaning process if the pressure detected by the base pressure detector is confirmed to be a specific pressure after running the cleaning fluid recovery process. Scale inside the drainpipe is gradually dissolved and removed through contact with the cleaning fluid. Therefore, if the cleaning process is repeated, each iteration of the cleaning process should result in less scale and therefore a larger conduit inside the drainpipe. The cleaning process can therefore be repeatedly executed without the cleaning fluid pressure inside the fluid delivery line rising above the predetermined pressure, and the scale can thus be completely dissolved and removed.

Yet further preferably, the control device additionally confirms how many times the cleaning fluid recovery process was executed, and if the execution count reaches a specific value, outputs an alarm and terminates operation. If the cleaning process and cleaning fluid recovery process are repeated and executed a specific number of times but the cleaning fluid pressure inside the fluid delivery line does not drop below the predetermined pressure level, the control device decides there is a problem, such as a foreign object clogging the drainpipe, and stops operation so that appropriate action can be taken efficiently.

A drainpipe cleaning apparatus according to another aspect of the invention also has a flow rate detector provided on the fluid delivery line. In this cleaning apparatus the control device monitors the cleaning fluid flow rate detected by the flow rate detector in the fluid delivery line during the cleaning process, runs the cleaning fluid recovery process if the detected flow rate reaches a specific flow rate, and then terminates operation when the cleaning fluid recovery process ends. When the scale on the inside walls of the drainpipe is dissolved and removed by the cleaning fluid, the inside diameter of the drainpipe increases and cleaning fluid flow through the drainpipe and fluid delivery line increases. The progress of the cleaning process and whether the cleaning process is completed can thus be determined based on the flow rate of cleaning fluid through the fluid delivery line detected by the flow rate detector, thus affording efficient operation.

The control device in yet another aspect of the invention runs the cleaning fluid recovery process after waiting for a specific time to pass after confirming that cleaning fluid flow through the fluid delivery line reached the specific flow rate, and then terminates operation when the cleaning fluid recovery process ends. Scale could still remain on parts of the inside walls of the drainpipe even after the flow of cleaning fluid inside the fluid delivery line reaches the specific flow rate. However, by continuing the cleaning process for a specific time after the cleaning fluid flow reaches the specified flow rate, scale can be more completely dissolved and removed.

Yet further preferably, after confirming that cleaning fluid flow detected by the flow rate detector in the fluid delivery line reached a specific flow rate, and before executing the cleaning fluid recovery process, the control device confirms that a specific time has elapsed since the cleaning process started. If the elapsed time exceeds this specific time, the control device executes the cleaning fluid recovery process and then terminates the cleaning process when the cleaning fluid recovery process ends. As described above, this arrangement can more completely dissolve and remove any remaining scale that might remain on part of the inside walls of the drainpipe.

### Effects of the Invention

A drainpipe cleaning method and drainpipe cleaning apparatus according to the present invention can thus effectively prevent cleaning fluid from leaking from the drainpipe while the drainpipe is being cleaned.

### BRIEF DESCRIPTION OF DRAWINGS

FIG. 1 is a schematic diagram of a cleaning apparatus according to a preferred embodiment of the invention.

FIG. 2 is a flow chart showing the control process of a control device according to a preferred embodiment of the invention.

FIG. 3 is a schematic diagram of a cleaning apparatus according to another preferred embodiment of the invention.

### Legend

1 cleaning apparatus
2, 2′ wastewater drainpipe
10, 10′ cleaning fluid tank
15, 15′ fluid delivery line
16, 16′ cleaning fluid pump
18, 18′ flow rate detector
19, 19′ discharge valve
20, 20′ inlet-side pressure detector
23, 23′ fluid drain line
24 gas-liquid separation tank
25 outlet pressure gauge
26 gas exhaust line
27 release valve
28 circulation line
30 base pressure detector
31 gas recovery line
32 gas recovery valve
33 cleaning fluid return line
34 cleaning fluid return valve
36 gas discharge pump
45 control device

### BEST MODE FOR CARRYING OUT THE INVENTION

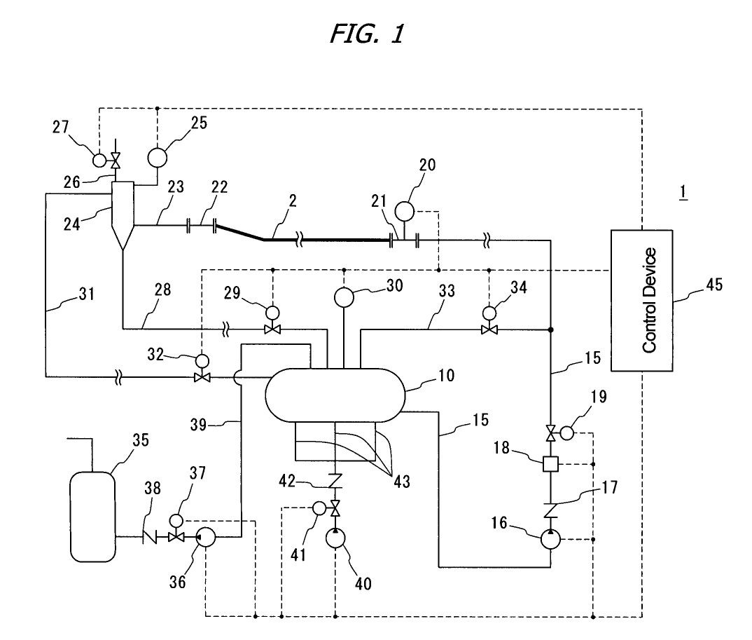

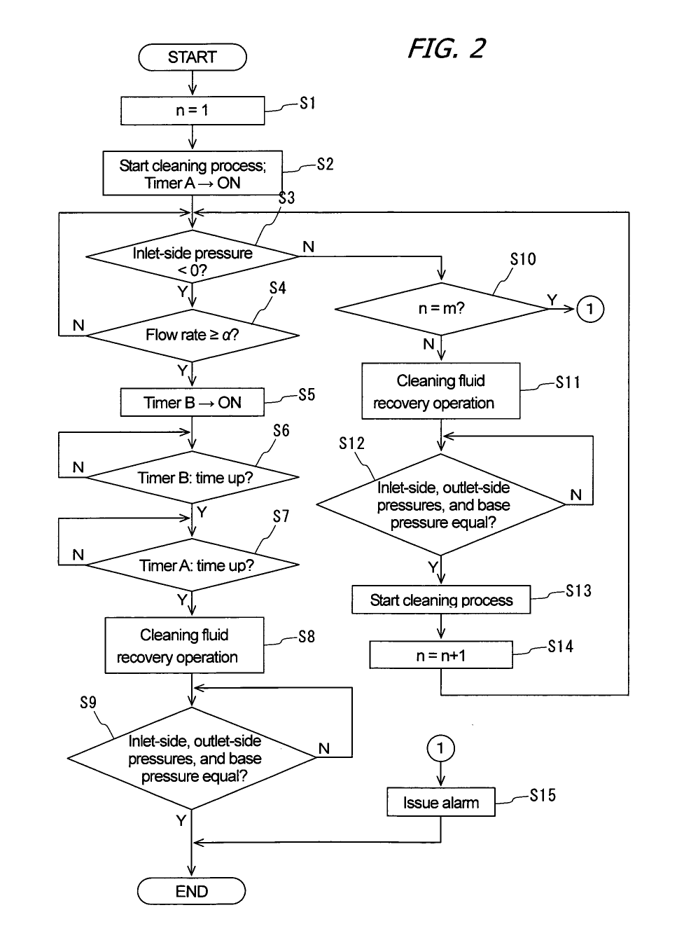

A preferred embodiment of the present invention is described below with reference to the accompanying figures, of which FIG. 1 is a schematic diagram of a cleaning apparatus according to a first embodiment of the invention, and FIG. 2 is a flow chart showing the control process of the control apparatus in this embodiment of the invention.

A cleaning apparatus 1 according to this embodiment of the invention as shown in FIG. 1 is used for cleaning a wastewater pipe 2 that is connected to a toilet or sink, for example, in a passenger plane, railroad car, bus, boat, or other type of moving vehicle or transit vessel. The cleaning apparatus 1 has a cleaning fluid tank 10 for storing cleaning fluid, a fluid delivery line 15, a fluid drain line 23, a gas-liquid separation tank 24, gas exhaust line 26, a circulation line 28, a gas recovery line 31, a cleaning fluid return line 33, an air intake line 39, an air supply line 43, a cleaning fluid pump 16, a gas discharge pump 36, a deodorizing mechanism 35, a blower 40, and a control device 45. The cleaning fluid pump 16 pressurizes cleaning fluid stored in the cleaning fluid tank 10 and thus supplies the cleaning fluid through the fluid delivery line 15 to the wastewater pipe 2. The gas discharge pump 36 externally vents gas from the cleaning fluid tank 10 through the air intake line 39. The deodorizing mechanism 35 deodorizes the gas vented by the gas discharge pump 36. The blower 40 supplies air into the cleaning fluid tank 10.

The cleaning apparatus 1 also has: a discharge valve 19 provided on the fluid delivery line 15 for opening and closing the conduit; a release valve 27 provided on the gas exhaust line 26 for opening and closing the pipe; a cleaning fluid recovery valve 29 provided on the circulation line 28 for opening and closing the conduit; a gas recovery valve 32 provided on the gas recovery line 31 for opening and closing the conduit; a cleaning fluid return valve 34 provided on the cleaning fluid return line 33 for opening and closing the conduit; an air intake valve 37 provided on the air intake line 39 for opening and closing the conduit; an air supply valve 41 provided on the air supply line 43 for opening and closing the conduit; a base pressure detector 30 provided on the cleaning fluid tank 10 for detecting the pressure inside the cleaning fluid tank 10; a inlet-side pressure detector 20 for detecting the pressure of the cleaning fluid inside the fluid delivery line 15; an outlet pressure gauge 25 provided on the gas-liquid separation tank 24 for detecting the pressure inside the gas-liquid separation tank 24; and a flow rate detector 18 for measuring the flow rate of the cleaning fluid inside the fluid delivery line 15.

The cleaning fluid stored in the cleaning fluid tank 10 can be suitably selected according to the composition and amount of scale deposited on the wastewater pipe 2 and the shape of the wastewater pipe 2. For removing scale composed of calcium compounds from the wastewater pipes 2 in a passenger plane, however, the cleaning fluid preferably contains at least one type of oxycarboxylic acid, such as L-malic acid or citric acid, and at least one type of sulfamic acid, such as amidosulfonic acid.

One end 21 of the fluid delivery line 15 is connected to the downstream end of the wastewater pipe 2, and the other end is connected to the cleaning fluid tank 10 below the fluid level of the cleaning fluid stored in the cleaning fluid tank 10. The inlet-side pressure detector 20 is provided on the one end 21 and the cleaning fluid pump 16 is provided on the other end of the fluid delivery line 15. A check valve 17 that allows the cleaning fluid to flow only to the wastewater pipe 2 is also provided on the other end of the fluid delivery line 15 downstream from the cleaning fluid pump 16 in the direction of cleaning fluid flow. The flow rate detector 18 is also provided on this other end of the fluid delivery line 15 downstream from the check valve 17, and the discharge valve 19 is similarly disposed downstream from the flow rate detector 18.

The gas-liquid separation tank 24 is a hollow cylindrical tank that tapers to a reduced diameter at the bottom and has the gas exhaust line 26 provided on the top of the separation tank. The gas-liquid separation tank 24 separates gas from the cleaning fluid flowing into the separation tank, and vents the gas inside the tank to the outside through the exhaust line 26. More specifically, when the cleaning fluid collides with the inside walls of the gas-liquid separation tank 24, the liquid and solid components fall to the bottom while the gas component rises to the top, thus separating the gas from the cleaning fluid.

One end 22 of the fluid drain line 23 is connected to the upstream end of the wastewater pipe 2, and the other end is connected to the outside middle part of the gas-liquid separation tank 24. One end of the circulation line 28 is connected to the bottom end of the gas-liquid separation tank 24, and the other end is connected to cleaning fluid tank 10 above the fluid level of the cleaning fluid in the cleaning fluid tank 10. The circulation line 28 thus returns the cleaning fluid degassed in the gas-liquid separation tank 24 to the cleaning fluid tank 10. One end of the gas recovery line 31 is connected to the outside top part of the gas-liquid separation tank 24, and the other end is connected to the cleaning fluid tank 10 above the fluid level of the cleaning fluid in the cleaning fluid tank 10. The gas recovery line 31 thus recovers the gas separated in the gas-liquid separation tank 24 into the cleaning fluid tank 10.

One end of the cleaning fluid return line 33 is connected to the fluid delivery line 15 between the wastewater pipe 2 and the discharge valve 19. The other end of the cleaning fluid return line 33 is connected to the cleaning fluid tank 10 above the fluid level of the cleaning fluid in the cleaning fluid tank 10.

One end of the air intake line 39 is connected to the cleaning fluid tank 10 above the fluid level of the cleaning fluid in the cleaning fluid tank 10, and the other end is connected to the deodorizing mechanism 35. The gas discharge pump 36 is also provided on this air intake line 39. The air intake valve 37 is also provided on the air intake line 39 downstream from the gas discharge pump 36 in the discharge direction, and a check valve 38 is disposed downstream from the air intake valve 37. This check valve 38 permits gas to only flow to the deodorizing mechanism 35.

The deodorizing mechanism 35 uses a suitable deodorizing agent to deodorize the gas flowing through the air intake line 39 for exhausting to the outside by the exhausting action of the gas discharge pump 36, and then releases the odorless gas to the atmosphere.

One end of the air supply line 43 is split into three lines each connected to the bottom of the cleaning fluid tank 10, and the other end is connected to blower 40. The air supply valve 41 is provided on the air supply line 43 downstream from the blower 40 in the direction of air flow, and a check valve 42 is disposed downstream from the air supply valve 41. The check valve 42 allows air to only flow downstream to where the air supply line 43 branches, that is, toward the cleaning fluid tank 10. The blower 40 blows air into the cleaning fluid tank 10 to mix the materials that constitute the cleaning fluid and are loaded into the cleaning fluid tank 10, thereby generating the cleaning fluid.

The control device 45 controls operation of the discharge valve 19, release valve 27, cleaning fluid recovery valve 29, gas recovery valve 32, cleaning fluid return valve 34, air intake valve 37, air supply valve 41, cleaning fluid pump 16, gas discharge pump 36, and blower 40. When an externally input start-cleaning signal is received, the control device 45 runs a process such as shown in FIG. 2 to clean the inside of the wastewater pipe 2 based on the detection signals supplied from the base pressure detector 30, inlet-side pressure detector 20, outlet pressure gauge 25, and flow rate detector 18.

More specifically, when the control device 45 receives the start-cleaning signal, the control device 45 first initializes the cleaning process count n to n=1 (step S1), then starts the cleaning process, and starts a timer A to measure the time elapsed since the start of the cleaning process (step S2).

To start the cleaning process, the control device 45 opens the discharge valve 19, closes the release valve 27, opens the cleaning fluid recovery valve 29, opens the gas recovery valve 32, closes the cleaning fluid return valve 34, opens the air intake valve 37, and closes the air supply valve 41. The control device 45 then drives the gas discharge pump 36 to purge any air inside the cleaning fluid tank 10 through the air intake line 39. When the pressure detected by the base pressure detector 30 goes to a specific negative pressure, the control device 45 determines that a specific vacuum state exists inside the cleaning fluid tank 10, fluid delivery line 15, wastewater pipe 2, fluid drain line 23, gas-liquid separation tank 24, circulation line 28, gas recovery line 31, and cleaning fluid return line 33, and thus drives the cleaning fluid pump 16 to supply cleaning fluid from the cleaning fluid tank 10 through the fluid delivery line 15 to the downstream end of the wastewater pipe 2.

The cleaning fluid thus supplied to the downstream end of the wastewater pipe 2 flows in reverse through the wastewater pipe 2 to dissolve and remove scale deposits on the inside walls of the wastewater pipe 2. The cleaning fluid is caused to flow backwards through the wastewater pipe 2, that is, to flow in the direction opposite the direction in which wastewater normally flows (that is, from the upstream to the downstream end of the drainpipe 2) through the wastewater drainpipe 2, to promote separation of the scale from the walls by applying pressure in the opposite direction as the direction in which the scale grows. This improves the scale removal effect (the cleaning effect) of the cleaning system.

The cleaning fluid flowing in reverse through the wastewater pipe 2 then passes through the fluid drain line 23 and enters the gas-liquid separation tank 24 together with the gases produced as the cleaning fluid dissolves and removes the scale. The gases are then separated from the fluid inside the gas-liquid separation tank 24, the degassed cleaning fluid returns to the cleaning fluid tank 10 through the circulation line 28, and the separated gases are recovered into the cleaning fluid tank 10 through the gas recovery line 31. The gases are separated from the fluid in the gas-liquid separation tank 24 to prevent cleaning fluid surges (hammering) inside the circulation line 28.

The gases recovered into the cleaning fluid tank 10 are then purged by the exhausting action of the gas discharge pump 36 through the air intake line 39 into the deodorizing mechanism 35, deodorized by the deodorizing mechanism 35, and released externally.

While this cleaning process is running, the control device 45 constantly monitors whether or not the pressure detected by the inlet-side pressure detector 20 is below atmospheric pressure (step S3). If the detected supply pressure is below atmospheric pressure and the flow detected by the flow rate detector 18 is greater than or equal to a specific flow rate, control goes to step S5 (step S4). When the scale on the inside walls of the wastewater pipe 2 is dissolved and removed by the cleaning fluid, the inside diameter of the wastewater pipe 2 increases and the flow of cleaning fluid through the wastewater pipe 2 and fluid delivery line 15 increases. When the flow of cleaning fluid detected by the flow rate detector 18 in the fluid delivery line 15 equals or exceeds a specific flow rate, the control device 45 determines that scale removal is substantially completed.

The control device 45 then starts a timer B that measures the time elapsed after the flow rate detector 18 detects that the cleaning fluid flow reached a specific flow rate (step S5), and checks if the elapsed time exceeds a specific time (step S6). If the elapsed time exceeds this specific time, control goes to step S7. Scale could still remain on parts of the inside walls of the wastewater pipe 2 even after the flow of cleaning fluid inside the fluid delivery line 15 reaches the specific flow rate. The cleaning process is therefore continued for a specific time after the cleaning fluid flow reaches the specified flow rate in order to more completely dissolve and remove the scale.

The control device 45 then determines if a specific time has passed since the cleaning process started (step S7). If the time since the cleaning process started exceeds this specific time, control goes to step S8. If the time since the cleaning process started does not exceed this specific time, scale may remain inside the wastewater pipe 2 as described above. The cleaning process is therefore always run for at least a constant period of time in order to more dependably dissolve and remove the scale.

The control device 45 then terminates the cleaning process described above and runs a cleaning fluid recovery process (step S8). For this cleaning fluid recovery process the control device 45 stops operation of the cleaning fluid pump 16, closes the discharge valve 19, opens the release valve 27, closes the gas recovery valve 32, and opens the cleaning fluid return valve 34. This allows air to flow into the gas-liquid separation tank 24 from the gas exhaust line 26 and then through the fluid drain line 23 into the wastewater pipe 2, thereby allowing the cleaning fluid in the wastewater pipe 2 to flow through the fluid delivery line 15 and cleaning fluid return line 33 and be recovered in the cleaning fluid tank 10.

If in step S9 the pressure detected by the base pressure detector 30, inlet-side pressure detector 20, and outlet pressure gauge 25 are substantially the same pressure and substantially equal to atmospheric pressure, the control device 45 determines that all of the cleaning fluid has been recovered from the wastewater pipe 2 and thus terminates the cleaning fluid recovery process.

Returning to step S3, if the pressure detected by the inlet-side pressure detector 20 is greater than or equal to atmospheric pressure, control goes to step S10. If, for example, large scale deposits have formed on the inside walls of the wastewater pipe 2 and the inside diameter of the wastewater pipe 2 has thus become small, the cleaning fluid pressure inside the wastewater pipe 2 can rise to or above atmospheric pressure, creating the danger of the cleaning fluid leaking from joints or other parts of the wastewater pipe 2. Therefore, if the pressure detected by the inlet-side pressure detector 20 equals or exceeds atmospheric pressure, the control device 45 determines that the cleaning fluid pressure inside the wastewater pipe 2 is also greater than or equal to atmospheric pressure and branches to step S10.

In step S10 the control device 45 determines if the cleaning process count n equals a constant count m. If the cleaning process count n is less than the constant count m, the cleaning fluid recovery process described above runs (step S11). If the pressure detected by the base pressure detector 30, inlet-side pressure detector 20, and outlet pressure gauge 25 are substantially the same pressure and substantially equal to atmospheric pressure (step S12), the control device 45 determines that all of the cleaning fluid has been recovered from the wastewater pipe 2, starts the cleaning process again (step S13), increments the cleaning process count n (n=n+1) (step S14), and returns to step S3.

If the pressure detected by the inlet-side pressure detector 20 is less than atmospheric pressure, operation continues from step S4. If the pressure detected by the inlet-side pressure detector 20 is greater than or equal to atmospheric pressure, the cleaning process and cleaning fluid recovery process (steps S10 to S14) repeat until the cleaning process count n equals the constant count m. If the cleaning process count n equals the constant count m (step S10), an alarm is output (step S15) and operation ends.

Scale inside the wastewater pipe 2 is gradually dissolved and removed through contact with the cleaning fluid. Therefore, if the cleaning process is repeated multiple times, each iteration of the cleaning process should result in less scale and therefore a larger diameter conduit inside the wastewater pipe 2. As a result, repeating the cleaning process as described above continues cleaning the wastewater pipe 2 while pre-exhausting the inlet pressure detected by the inlet-side pressure detector 20 (the cleaning fluid pressure inside the wastewater pipe 2) from rising to or exceeding atmospheric pressure, and thus completely dissolves and removes any scale.

Furthermore, if the pressure detected by the inlet-side pressure detector 20 does not go below atmospheric pressure by the time the cleaning process count n reaches the constant count m, there is probably a problem such as the wastewater pipe 2 being clogged by some object. An alarm is therefore issued so that appropriate action can be taken.

A cleaning apparatus 1 according to the embodiment of the invention described above cleans the inside of the wastewater pipe 2 as described below. After first loading the materials from which the cleaning fluid is made into the cleaning fluid tank 10, the control device 45 opens the air supply valve 41 and drives the blower 40. This supplies air through the air supply line 43 into the cleaning fluid tank 10 to mix the components of the cleaning fluid and thereby generate the cleaning fluid.

A cleaning fluid circulation line between the cleaning fluid tank 10 and wastewater pipe 2 is formed by connecting the one end 21 of the fluid delivery line 15 to the downstream end of the wastewater pipe 2 and connecting the one end 22 of the fluid drain line 23 to the upstream end of the wastewater pipe 2. The control device 45 then runs a process as shown in FIG. 2 to dissolve and remove scale inside the wastewater pipe 2 by means of the cleaning fluid.

As described above, the cleaning apparatus 1 according to this embodiment of the invention detects and monitors the cleaning fluid pressure inside the fluid delivery line 15 at the wastewater pipe 2 inlet by means of the inlet-side pressure detector 20 while running the cleaning process, and if the detected pressure is greater than or equal to atmospheric pressure, determines that the cleaning fluid pressure inside the wastewater pipe 2 exceeds atmospheric pressure and therefore runs the cleaning fluid recovery process. The cleaning apparatus 1 according to this embodiment of the invention can thus clean the wastewater pipe 2 while effectively pre-exhausting cleaning fluid from leaking from the wastewater pipe 2.

Furthermore, if the pressure detected by the inlet-side pressure detector 20 becomes greater than or equal to atmospheric pressure, the cleaning fluid recovery process is run to recover the cleaning fluid into the cleaning fluid tank 10, the cleaning process is then repeated, and the cleaning fluid recovery process and cleaning process are repeated up to a specific number of times. By thus repeating the cleaning process, the cleaning apparatus 1 gradually dissolves and removes scale from the inside walls of the wastewater pipe 2.

Yet further, if the pressure detected by the inlet-side pressure detector 20 does not go below atmospheric pressure even after repeating the cleaning fluid recovery process and cleaning process the specified number of times, there is a problem such as some foreign object clogging the wastewater pipe 2. An alarm is therefore issued and operation stops so that appropriate action can be taken efficiently.

As also described above, the flow rate detector 18 detects the flow rate of cleaning fluid flowing through the fluid delivery line 15, and the cleaning apparatus 1 can determine that the scale has been substantially removed from the walls of the wastewater pipe 2 when the detected flow rate is greater than or equal to a specified level. This can therefore be used to determine the progress of scale removal.

How much time has passed since the flow rate detected by the flow rate detector 18 reached the specified flow rate is also measured, and control goes to the next step when this elapsed time reaches a specified time. How much time has passed since the cleaning process started is also measured, and control goes to the next step when this elapsed time exceeds a specified time. As a result, scale can be dissolved and removed even more dependably.

A preferred embodiment of the invention is described above, and it will be obvious to one with ordinary skill in the related art that specific embodiments of the invention are not so limited.

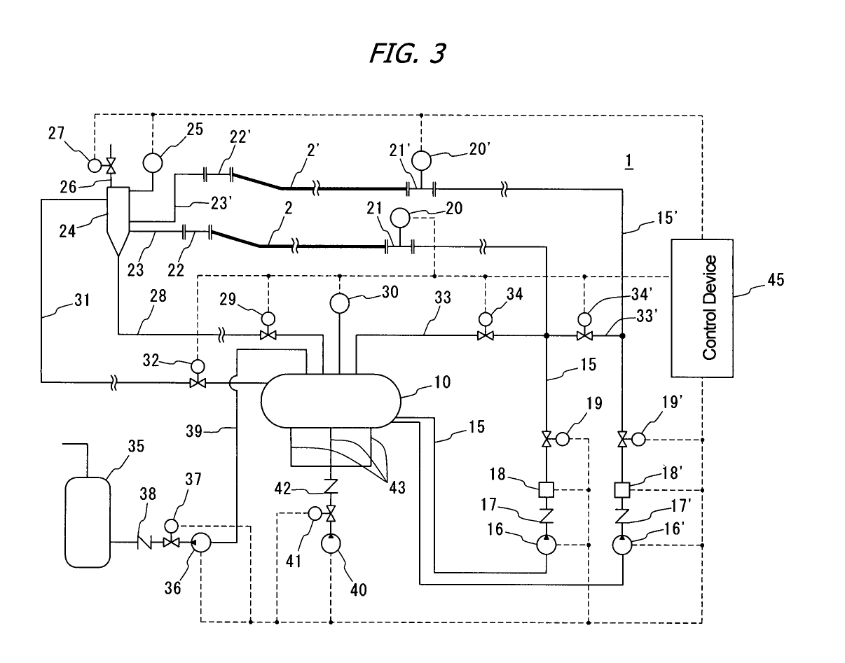

As shown in FIG. 3, for example, the cleaning apparatus 1 can be rendered to clean a plurality of wastewater pipes 2, 2′ using a plurality of cleaning channels (only two shown in FIG. 3) comprising a fluid delivery line 15, cleaning fluid pump 16, check valve 17, flow rate detector 18, discharge valve 19, inlet-side pressure detector 20, fluid drain line 23, cleaning fluid return line 33, and cleaning fluid return valve 34 as described above on one channel and a functionally identical fluid delivery line 15′, cleaning fluid pump 16′, check valve 17′, flow rate detector 18′, discharge valve 19′, inlet-side pressure detector 20′, fluid drain line 23′, cleaning fluid return line 33′, and cleaning fluid return valve 34′ on the other channel.

In this arrangement the one end 21′ of the fluid delivery line 15′ is connected to the downstream end of the wastewater pipe 2′, the one end 22′ of the fluid drain line 23′ is connected to the upstream end of the wastewater pipe 2′, one end of the cleaning fluid return line 33′ is connected to the fluid delivery line 15′ between the wastewater pipe 2′ and discharge valve 19′, and the other end of the cleaning fluid return line 33′ is connected to the joint between the fluid delivery line 15 and cleaning fluid return line 33.

During the cleaning process, the cleaning fluid pumps 16, 16′ in this cleaning apparatus 1 supply cleaning fluid from the cleaning fluid tank 10 to the wastewater pipes 2, 2′. During the cleaning fluid recovery process, the cleaning fluid return valves 34, 34′ are open so that cleaning fluid in the wastewater pipes 2, 2′ is recovered into the cleaning fluid tank 10 through the cleaning fluid return lines 33, 33′.

The one end 21, 21′ of the fluid delivery line 15, 15′ is connected to the downstream end of the wastewater pipe 2, 2′ in the cleaning apparatus 1 shown in FIG. 1 and FIG. 3, but the invention is not limited to this arrangement. More particularly, the one end 21, 21′ of the fluid delivery lines 15, 15′ can be connected to the wastewater collection tank (not shown in the figure) in which the wastewater is collected and to which the downstream ends of the wastewater pipes 2, 2′ are connected.

Furthermore, the control device 45 in the above examples controls operation of the discharge valve 19, release valve 27, gas recovery valve 32, cleaning fluid return valve 34, and cleaning fluid pump 16, for example, based on the detection values supplied from the base pressure detector 30, inlet-side pressure detector 20, outlet pressure gauge 25, and flow rate detector 18, but the invention is not limited to this arrangement. More particularly, the operator can check the output readings of the base pressure detector 30, inlet-side pressure detector 20, outlet pressure gauge 25, and flow rate detector 18, and manually control opening and closing the discharge valve 19, release valve 27, gas recovery valve 32, and cleaning fluid return valve 34, and the operation of the cleaning fluid pump 16, for example.

### INDUSTRIAL APPLICABILITY

A drainpipe cleaning method and drainpipe cleaning apparatus according to the present invention can thus be beneficially used to clean the inside of drainpipes installed in a transit vessel, and to remove scale deposits on the inside walls of the drainpipes.

1. A method of cleaning a drainpipe installed in a transit vessel, characterized by:
through a fluid delivery line, connecting a cleaning fluid tank storing cleaning fluid with a downstream end of the drainpipe, and through a fluid drain line connecting the cleaning fluid tank with an upstream end of the drainpipe;
thereafter running a cleaning process for cleaning inside the drainpipe by bringing the cleaning fluid tank, fluid delivery line, drainpipe, and fluid drain line internally to a predetermined negative pressure, and supplying cleaning fluid from the cleaning fluid tank to the downstream end of the drainpipe via the fluid delivery line, reverse-flushing the cleaning fluid through the drainpipe to circulate the cleaning fluid back to the cleaning fluid tank through the fluid drain line;
while running the cleaning process, monitoring cleaning fluid pressure near the drainpipe by detecting the fluid pressure inside the fluid delivery line; and
if the detected cleaning fluid pressure exceeds a predetermined pressure, running a cleaning fluid recovery process of stopping supply of cleaning fluid to the drainpipe, and opening a portion of the fluid drain line to the atmosphere to pass the cleaning fluid from the drainpipe through the supply line and recover the cleaning fluid into the cleaning fluid tank.

2. The drainpipe cleaning method set forth in claim 1, characterized in being rendered so that the cleaning process is restarted after the cleaning fluid recovery process has been run.

3. The drainpipe cleaning method set forth in claim 2, characterized in being rendered so that when the cleaning process is restarted following the cleaning fluid recovery process, if during the cleaning process the cleaning fluid pressure inside the fluid delivery line exceeds the predetermined pressure, the cleaning fluid recovery process and cleaning restart process are run repeatedly, and once the number of cleaning-fluid-recovery-process run cycles reaches a predetermined count, all processes are terminated.

4. The drainpipe cleaning method set forth in claim 1, characterized in being rendered so that while the cleaning process is being run, the rate of cleaning fluid flow through the fluid delivery line is monitored by detecting the flow, and once the cleaning fluid flow reaches a predetermined flow rate, all processes are terminated.

5. The drainpipe cleaning method set forth in claim 4, characterized in being rendered so that following confirmation that the rate of cleaning fluid flow through the fluid delivery line has reached the predetermined flow rate, the passage of a predetermined time period is awaited before terminating all processes.

6. The drainpipe cleaning method set forth in claim 4, characterized in being rendered so that upon confirming that the rate of cleaning fluid flow through the fluid delivery line has reached the predetermined flow rate, the time elapsed since the start of the cleaning process started is checked, and when the elapsed time has exceeded a predetermined time period, all processes are terminated.

7. A drainpipe cleaning apparatus for cleaning a drainpipe installed in a transit vessel, characterized by being configured to comprise:
a cleaning fluid tank for storing cleaning fluid;
an evacuation means for exteriorly evacuating gas inside the cleaning fluid tank to bring the tank interior to a negative pressure;
a base pressure detector for detecting pressure inside the cleaning fluid tank;
a fluid delivery line connected at one end to the downstream end of the drainpipe;
a fluid delivery means connected to the cleaning fluid tank, for pressurizing the cleaning fluid within the tank to supply the cleaning fluid to the other end of the fluid delivery line;
a discharge valve provided on the fluid delivery line for opening and closing the conduit within the fluid delivery line;
a cleaning fluid return line connected at one end to the fluid delivery line between the drainpipe and discharge valve, and connected at the other end to the cleaning fluid tank;
a cleaning fluid return valve provided on the cleaning fluid return line for opening and closing the conduit inside the cleaning fluid return line;
a inlet-side pressure detector provided proximate to the one end of the fluid delivery line, for detecting cleaning fluid pressure within the conduit in the vicinity of the one end;
a fluid drain line connected at one end to the upstream end of the drainpipe;
a gas-liquid separation tank connected to the other end of the fluid drain line, for separating out gas within cleaning fluid recovered from the fluid drain line;
an exhaust line connected to the gas-liquid separation tank for exteriorly exhausting gas inside the gas-liquid separation tank, the exhaust line being provided with a release valve for opening and closing the conduit inside the exhaust line;
a circulation line connected at one end to the gas-liquid separation tank, and connected at the other end to the cleaning fluid tank, for circulating recovered cleaning fluid in the gas-liquid separation tank back to the cleaning fluid tank;
a gas recovery line connected at one end to the gas-liquid separation tank and connected at the other end to the cleaning fluid tank, for recovering into the cleaning fluid tank gas separated inside the gas-liquid separation tank;
a gas recovery valve provided on the gas recovery line for opening and closing the conduit inside the gas recovery line; and
a control device for controlling operation of the evacuation means, fluid delivery means, discharge valve, cleaning fluid return valve, release valve, and gas recovery valve; and characterized in that
said control device is configured such that
while running a cleaning process in which said control device
drives the evacuation means and fluid delivery means,
brings the interior of the cleaning fluid tank to a predetermined negative pressure by putting the discharge valve open, the cleaning fluid return valve closed, the release valve closed, and the gas recovery valve opened,
supplies cleaning fluid to the downstream end of the drainpipe, and reverse-flushes the cleaning fluid through the drainpipe to recover the cleaning fluid into the gas-liquid separation tank, and then
circulates the cleaning fluid to the cleaning fluid tank,
said control device monitors the pressure detected by the inlet-side pressure detector, and if the detected pressure exceeds a predetermined pressure,
said control device runs a cleaning fluid recovery process in which said control device
halts the fluid delivery means, and
by putting the discharge valve closed, the cleaning fluid return valve open, the gas recovery valve closed, and the release valve open, recovers into the cleaning fluid tank the cleaning fluid in the drainpipe, through the fluid delivery line and through cleaning fluid return line branching from the fluid delivery line.

8. The drainpipe cleaning apparatus set forth in claim 7, characterized in being configured so that after running the cleaning fluid recovery process the control device restarts the cleaning process if the pressure detected by the base pressure detector is confirmed to have become a predetermined pressure.

9. The drainpipe cleaning apparatus set forth in claim 8, characterized in being configured so that said control device additionally checks the number of cleaning-fluid-recovery-process run cycles, and when the run count has reached a predetermined count, said control device outputs an alarm and terminates all processes.

10. The drainpipe cleaning apparatus according to claim 7, characterized by being configured:
to further comprise a flow rate detector provided in the fluid delivery line; and
so that while running the cleaning process said control device monitors the cleaning fluid flow rate in the fluid delivery line detected by the flow rate detector, once the flow rate reaches a predetermined flow rate, said control device runs the cleaning fluid recovery process, and terminates all processes after running the cleaning fluid recovery process.

11. The drainpipe cleaning apparatus set forth in claim 10, characterized by being configured so that after confirming that the rate of cleaning fluid flow through the fluid delivery line has reached the predetermined flow rate, said control device awaits the passage of a predetermined time period, runs the cleaning fluid recovery process, and terminates all processes after running the cleaning fluid recovery process.

12. The drainpipe cleaning apparatus set forth in claim 10, characterized by being configured so that after confirming that the rate of cleaning fluid flow through the fluid delivery line as detected by the flow rate detector has reached the predetermined flow rate, said control device before running the cleaning fluid recovery process checks time elapsed since the start of the cleaning process, and when the elapsed time has exceeded a predetermined time period, said control device runs the cleaning fluid recovery process, and terminates all processes after running the cleaning fluid recovery process.
